(19) United States
(12) Patent Application Publication
(10) Pub. No.: US 2016/0087901 A1
(43) Pub. Date: Mar. 24, 2016

(54) TRANSMISSION APPARATUS AND TRANSMISSION METHOD

(71) Applicant: FUJITSU LIMITED, Kawasaki-shi (JP)

(72) Inventor: Yasuyuki Mitsumori, Kawasaki (JP)

(73) Assignee: Fujitsu Limited, Kawasaki (JP)

(21) Appl. No.: 14/809,708

(22) Filed: Jul. 27, 2015

(30) Foreign Application Priority Data
Sep. 22, 2014 (JP) 2014-193006

(51) Int. Cl. H04L 12/819

(52) U.S. Cl. CPC H04L 47/215

(57) ABSTRACT

A transmission apparatus includes: a memory; one or more processors coupled to the memory and the one or more processors execute: a first management process that manages a remaining amount of tokens in a token bucket; a second management process that manages an amount of data of a frame transmitted in a predetermined period of time; and a transmission control process that controls transmission of a frame to be transmitted, based on whether the remaining amount of tokens is larger than or equal to an amount of data of the frame to be transmitted and whether the amount of data of the frame transmitted in the predetermined period of time is smaller than a predetermined amount.

### CROSS-REFERENCE TO RELATED APPLICATION

This application is based upon and claims the benefit of priority of the prior Japanese Patent Application No. 2014-193006, filed on Sep. 22, 2014, the entire contents of which are incorporated herein by reference.

### FIELD

The embodiments discussed herein are related to a transmission apparatus and a transmission method.

### BACKGROUND

With widespread use of the Internet and mobile networks in recent years, carrier networks managed and operated by communication service providers are changed from synchronous networks, such as Time Division Multiplexing (TDM) networks, to asynchronous networks. In asynchronous carrier networks, band-guaranty services, which guarantee bands that are used, may be provided to users (clients) of the networks as one service provided to clients. In the band-guaranty services, communication equipment that is installed on the networks performs band control on frames that the users transmit, in order to ensure that the bands do not exceed a maximum band guaranteed for the users. The “band control” refers to controlling the amount of data transferred per unit time, and is represented using bits per second (bps), which indicates the amount of bits transmitted per second.

Each piece of communication equipment installed on the networks performs the band control by using, for example, a technology called the token bucket system. In the token bucket system, tokens are put in a storage area, called a token bucket, at a rate corresponding to the guaranteed band. Upon receiving frames, each piece of communication equipment transmits the frames, when tokens corresponding to the amount of data of the received frames exist in the token bucket. Each piece of communication equipment then removes, from the token bucket, tokens corresponding to the amount of data of the transmitted frames. With this arrangement, each piece of communication equipment that is installed on the network can perform the band control.

Related art is disclosed in Japanese Laid-Open Patent Publication No. 2005-244417 and Japanese Laid-Open Patent Publication No. 2013-26986.

In asynchronous networks, the size of frames to be transmitted has a variable length, and frames are transmitted irregularly. Thus, in each piece of communication equipment provided on the network, the size of the token bucket is increased to some degree to store extra tokens, and frame transmission is controlled so as to satisfy the guaranteed band on a long term basis.

However, in the token bucket system, when frame transmission has not been performed for a while, a large number of tokens are accumulated in the token bucket. Thus, when a plurality of frames having burstiness are continuously received in a short period of time in a state in which frame transmission has not been performed for a while, frames having an amount of data corresponding to the tokens in the token bucket are transferred with burstiness. When data having burstiness is transmitted, a reception buffer may overflow in the communication equipment at a receiving end.

When the size of the token bucket is reduced, the burstiness of frames that are transmitted can be reduced, but the capacity that temporarily stores tokens decreases. Thus, it is difficult to provide a sufficient-band-guaranty service for frames that are transmitted irregularly.

The technology disclosed herein suppresses a burst of frames to be transmitted, while maintaining a guaranteed band.

### SUMMARY

According to an aspect of the embodiments, a transmission apparatus includes: a memory; one or more processors coupled to the memory and the one or more processors execute: a first management process that manages a remaining amount of tokens in a token bucket; a second management process that manages an amount of data of a frame transmitted in a predetermined period of time; and a transmission control process that controls transmission of a frame to be transmitted, based on whether the remaining amount of tokens is larger than or equal to an amount of data of the frame to be transmitted and whether the amount of data of the frame transmitted in the predetermined period of time is smaller than a predetermined amount.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a communication system;

FIG. 2 is a block diagram illustrating an example of a communication apparatus;

FIG. 3 is a block diagram illustrating an example of a control circuit in a first embodiment;

FIG. 4 is a graph illustrating an example of frame transmission control in the first embodiment;

FIG. 5 is a graph illustrating frame transmission control in a comparative example;

FIG. 6 is a graph illustrating frame transmission control in the comparative example;

FIG. 7 is a flowchart illustrating an example of transmission control processing in the first embodiment;

FIG. 8 is a block diagram illustrating an example of a control circuit in a second embodiment;

FIG. 9 is a graph illustrating frame transmission control in the second embodiment;

FIG. 10 is a flowchart illustrating an example of transmission control processing in the second embodiment;

FIG. 11 is a block diagram illustrating an example of a control circuit in a third embodiment;

FIG. 12 is a graph illustrating an example of frame transmission control in the third embodiment;

FIG. 13 is a flowchart illustrating an example of counter control processing in the third embodiment;

FIG. 14 is a flowchart illustrating an example of transmission control processing in the third embodiment;

FIG. 15 is a graph illustrating frame transmission control in a fourth embodiment;

FIG. 16 is a flowchart illustrating an example of counter control processing in the fourth embodiment;

FIG. 17 is a flowchart illustrating an example of transmission control processing in the fourth embodiment; and

FIG. 18 is a diagram illustrating an example of the hardware of the control circuit.

### DESCRIPTION OF EMBODIMENTS

Embodiments of a transmission apparatus and a transmission method disclosed herein will be described below with reference to the accompanying drawings. The embodiments described below are not intended to limit the technology according to the present disclosure. The individual embodiments may also be combined as appropriate within a scope that causes no contradiction in processing details.

### First Embodiment

[Overview of Communication System 10]

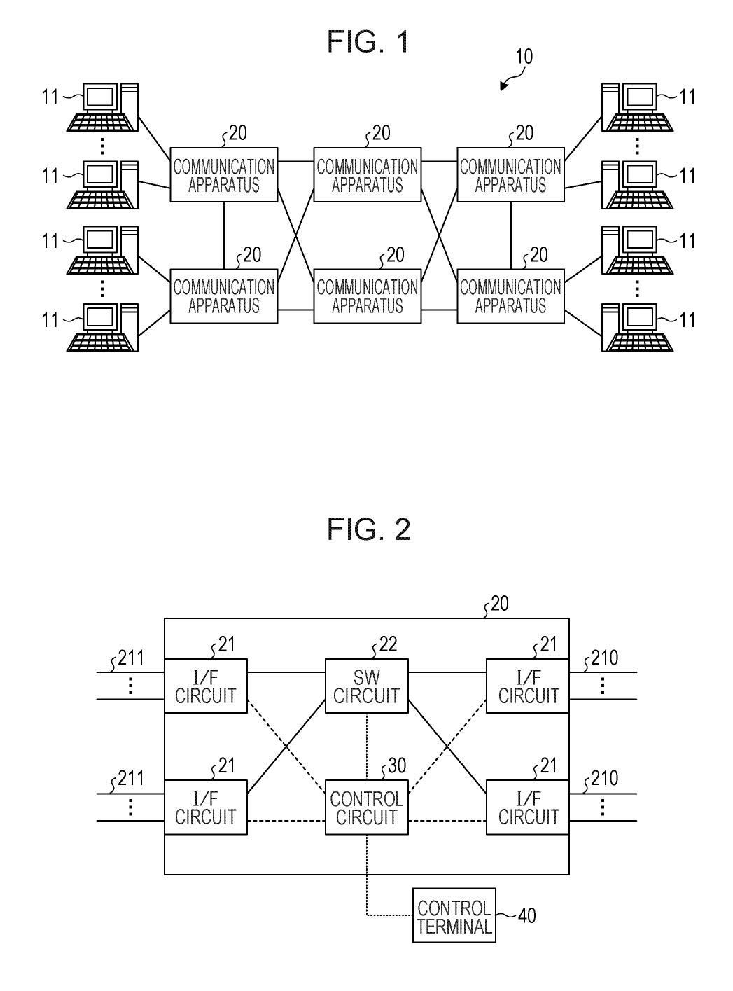

FIG. 1 is a diagram illustrating an example of a communication system 10. The communication system 10 has a plurality of communication apparatuses 20. Each of the communication apparatuses 20 is connected to one or more of the other communication apparatuses 20. A plurality of user terminals 11 are connected to some of the communication apparatuses 20 through access channels. Each communication apparatus 20 is managed by, for example, a communication service provider that provides a band-guaranty service to each user.

Each communication apparatus 20 receives frames transmitted from the corresponding user terminal 11 or another communication apparatus 20 and stores the received frames in a frame buffer. For example, based on address information of each of the frames stored in the frame buffer, the communication apparatus 20 determines a port via which each frame in the frame buffer is to be transmitted. The communication apparatus 20 then transmits each frame in the frame buffer to the corresponding user terminal 11 or another communication apparatus 20 via the determined port.

In the present embodiment, frames transmitted from each user terminal 11 have a format based on, for example, an Ethernet (trademark) standard. Ethernet frames are variable-length frames and are transmitted asynchronously. Each communication apparatus 20 transmits/receives Ethernet frames.

When the communication apparatus 20 connected to the other communication apparatuses 20 receives, from the other communication apparatuses 20, a predetermined number of frames or more in a certain period of time, the frame buffer overflows, and the communication apparatus 20 discards the frames. Consequently, the communication quality deteriorates, and a communication-traffic increase due to re-transmission of the frames occurs. Accordingly, it is preferable that each communication apparatus 20 transmit the frames to another communication apparatus 20, while reducing the burstiness.

[Communication Apparatus 20]

FIG. 2 is a block diagram illustrating an example of each communication apparatus 20. The communication apparatus 20 has a plurality of interface (I/F) circuits 21, a switch (SW) circuit 22, and a control circuit 30. The I/F circuits 21 are connected to the SW circuit 22 through corresponding signal lines through which data of frames are mainly transmitted. The I/F circuits 21 and the SW circuit 22 are connected to the control circuit 30 through corresponding control lines through which control signals are transmitted. In the example illustrated in FIG. 2, the signal lines in the communication apparatus 20 are represented by solid lines, and the control lines in the communication apparatus 20 are represented by dashed lines.

Each I/F circuit 21 has a plurality of channel ports 210. Each channel port 210 is connected to the corresponding user terminal 11 or another communication apparatus 20. Each I/F circuit 21 receives frames transmitted from the corresponding user terminal 11 or another communication apparatus 20 via the channel port 210. In accordance with an instruction from the control circuit 30, each I/F circuit 21 sends received frames to the SW circuit 22. Each I/F circuit 21 also receives frames sent from the SW circuit 22. The I/F circuit 21 transmits the received frames to the corresponding user terminal 11 or another communication apparatus 20 via the channel port 210 indicated by an instruction from the SW circuit 22.

The SW circuit 22 receives frames sent from each I/F circuit 21, and determines the channel port 210 via which the received frames are to be transmitted, based on address information of the received frames and so on. The SW circuit 22 sends the received frames to the I/F circuit 21 having the determined channel port 210 and transmits the frames via the determined channel port 210.

When each I/F circuit 21 receives frames via the channel port 210, the control circuit 30 controls transmission of the frames received by the I/F circuit 21, based on a guaranteed band preset for a user at the transmission source or the destination of the received frames. The control circuit 30 is connected to a control terminal 40 through a control line to receive various types of setting information input from an administrator of the communication apparatus 20 via the control terminal 40.

In the present embodiment, the I/F circuits 21, the SW circuit 22, and the control circuit 30 are provided, for example, in the form of detachable modules or cards. The I/F circuits 21, the SW circuit 22, and the control circuit 30 may be disposed, for example, on/in one substrate and be provided in the form of one module or card.

[Control Circuit 30]

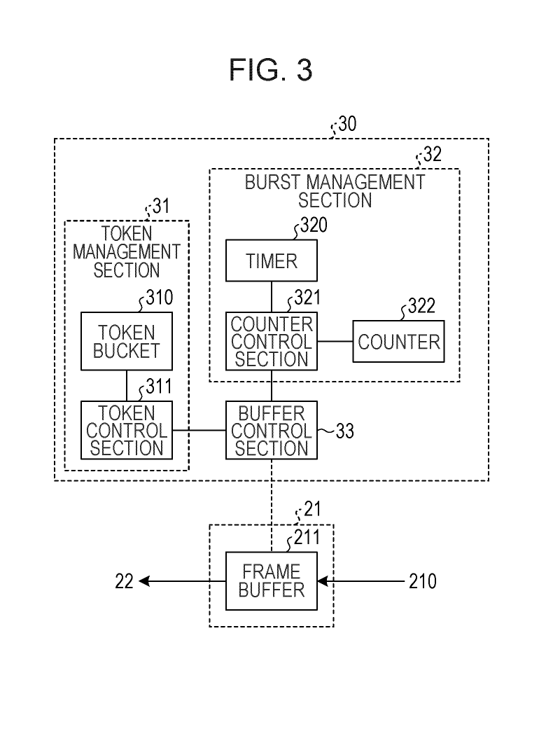

FIG. 3 is a block diagram illustrating an example of the control circuit 30 in the first embodiment. The control circuit 30 in the present embodiment has a token management section 31, a burst management section 32, and a buffer control section 33. In the present embodiment, the token management section 31, the burst management section 32, and the buffer control section 33 are provided, for example, for each user for which the band is controlled.

The token management section 31 has a token bucket 310 and a token control section 311. The token bucket 310 can hold tokens up to a predetermined upper-limit value. Tokens are put in the token bucket 310 at a bit rate corresponding to the band guaranteed for a corresponding user. When tokens are put in the token bucket 310 to the upper-limit value, tokens that exceed the upper-limit value are not put in the token bucket 310.

In the present embodiment, the upper-limit value of the token bucket 310 is, for example, a value corresponding to a few times the amount of data of a largest-size frame transmitted through a channel for a corresponding user. The amount of data of the largest-size frame is, for example, a few thousands of bits. In the present embodiment, one token corresponds to one bit. Thus, when a communication band of 100 Mbps is guaranteed for a user, for example, a billion tokens are put in the token bucket 310, for example, in one second.

Upon receiving a query from the buffer control section 33, the token control section 311 refers to the token bucket 310 and returns the remaining amount of tokens in the token bucket 310 to the buffer control section 33. Also, upon receiving, from the buffer control section 33, the amount of data of a frame to be transmitted, the token control section 311 removes, from the token bucket 310, tokens corresponding to the received amount of data.

The burst management section 32 has a timer 320, a counter control section 321, and a counter 322. The timer 320 repeatedly measures a certain period of time (for example, 1 millisecond). The counter 322 holds, as a count value, a value corresponding to the amount of data of the frame that is transmitted. In the present embodiment, the counter 322 holds, for example, as a count value of 1, the amount of 1-bit data of a frame that is transmitted.

Upon receiving a query from the buffer control section 33, the counter control section 321 reads the count value of the counter 322 and returns the read count value to the buffer control section 33. Also, upon receiving, from the buffer control section 33, the amount of data of a frame to be transmitted, the counter control section 321 adds a count value corresponding to the received amount of data to the count value of the counter 322. Also, each time the timer 320 finishes the measurement of the certain period of time, the counter control section 321 resets the count value of the counter 322 to 0.

Each I/F circuit 21 has a frame buffer 211. Upon receiving frames through the channel port 210, the frame buffer 211 holds the received frames. The frame buffer 211 then sets the held frames as frames to be transmitted in the order that they are received and notifies the buffer control section 33 about the amount of data of each frame to be transmitted. In response to a transmission instruction from the buffer control section 33, the frame buffer 211 sends, to the SW circuit 22, the frame to be transmitted.

The buffer control section 33 controls transmission of the frame to be transmitted, based on whether the remaining amount of tokens in the token bucket 310 is larger than or equal to the amount of data of the frame to be transmitted and whether the amount of data of the frame transmitted in a predetermined period of time is smaller than a predetermined amount. For example, upon receiving, from the frame buffer 211, the amount of data of the frame to be transmitted, the buffer control section 33 queries the token control section 311 about the remaining amount of tokens.

When the remaining amount of tokens which is returned from the token control section 311 is larger than or equal to the amount of data of the frame to be transmitted, the buffer control section 33 queries the counter control section 321 about the count value of the counter 322. When the count value returned from the counter control section 321 is smaller than a predetermined upper-limit value, the buffer control section 33 issues, to the frame buffer 211, an instruction for transmitting the frame to be transmitted.

The buffer control section 33 then sends, to the token control section 311, the amount of data of the frame that is transmitted. As a result, tokens corresponding to the amount of data of the frame that is transmitted are removed from the token bucket 310. Also, the buffer control section 33 sends, to the counter control section 321, the amount of data of the frame that is transmitted. As a result, a count value corresponding to the amount of data of the frame that is transmitted is added to the count value of the counter 322.

When the number of tokens in the token bucket 310 is one or more and the count value of the counter 322 is smaller than the predetermined upper-limit value, the buffer control section 33 may issue, to the frame buffer 211, an instruction for transmitting the frame to be transmitted. When the tokens in the token bucket 310 are less than the amount of data of the frame that is transmitted, tokens corresponding to the amount of data of the frame that is transmitted are removed from the token bucket 310, so that the amount of tokens in the token bucket 310 temporarily has a negative value. Then, the transmission of the frame to be transmitted is suspended until the amount of tokens in the token bucket 310 reaches 1 or more.

[Frame Transmission Control]

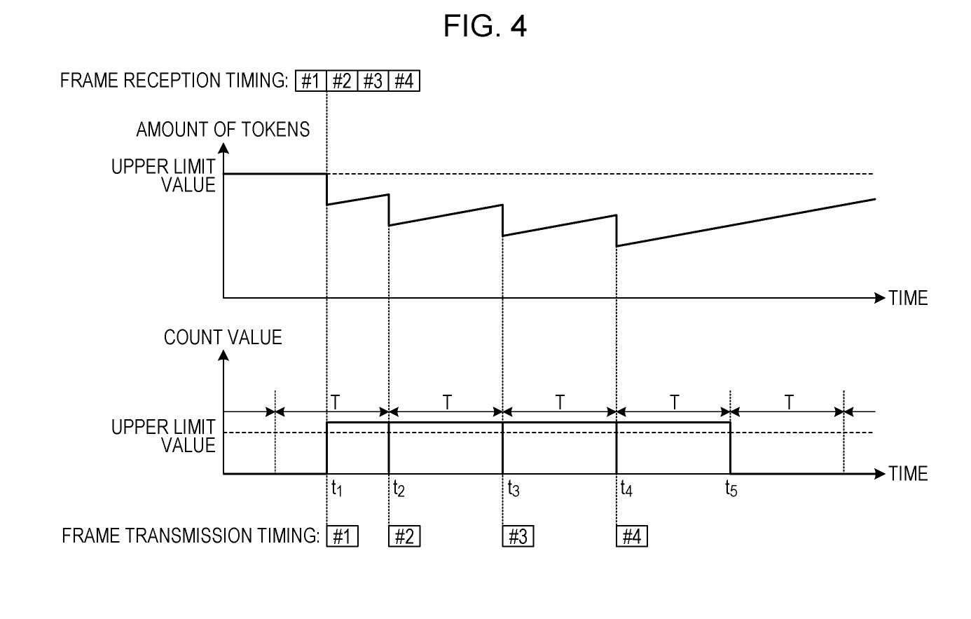

FIG. 4 is a graph illustrating an example of frame transmission control in the first embodiment. The top section in FIG. 4 illustrates frame reception timings at the frame buffer 211. Also, in FIG. 4, the second section from top illustrates changes the amount of tokens in the token bucket 310 with time. In FIG. 4, the third section from top illustrates changes in the count value of the counter 322 with time. The bottom section in FIG. 4 illustrates an example of frame transmission timings at the frame buffer 211.

In the example in FIG. 4, #1, #2, . . . represent respective frames, and the numerical values indicate the order that the frames are received or transmitted. In the example illustrated in FIG. 4, for simplification of the description, it is assumed that the amount of data of each frame is the amount of data corresponding to a count value that is larger than or equal to an upper-limit value. It is also assumed that frame transmission has not been performed for a while until a point in time immediately before frame #1 is transmitted, tokens up to the upper-limit value are held in the token bucket 310, and the count value of the counter 322 is 0.

For example, as illustrated in FIG. 4, at time point t₁ by which frame transmission has not been performed for a while, the frame buffer 211 receives frames #1 to #4 continuously transmitted with burstiness. At time point t₁, tokens that are more than or equal to the amount of data of frame #1 remain in the token bucket 310, and the count value of the counter 322 is smaller than the upper-limit value. Thus, the buffer control section 33 immediately issues, to the frame buffer 211, an instruction for transmission.

For example, at time point t₁ illustrated in FIG. 4, the frame buffer 211 sends, to the SW circuit 22, frame #1 to be transmitted. The SW circuit 22 then determines a channel port via which frame #1 is to be transmitted and causes the I/F circuit 21 having the determined channel port to transmit frame #1. As a result, at time point t₁, frame #1 is transmitted from the communication apparatus 20.

Also, at time point t₁ at which frame #1 is transmitted, the buffer control section 33 sends, to the token control section 311, the amount of data of frame #1 that is transmitted. The token control section 311 removes, from the token bucket 310, tokens corresponding to the amount of data of frame #1 that is transmitted. As a result, at time point t₁, the tokens in the token bucket 310 are reduced by an amount corresponding to the amount of data of frame #1 that is transmitted.

Also, at time point t₁ at which frame #1 is transmitted, the buffer control section 33 sends, to the counter control section 321, the amount of data of frame #1 that is transmitted. The counter control section 321 adds a count value corresponding to the amount of data of frame #1 that is transmitted to the count value of the counter 322. As a result, at time point t₁, the count value of the counter 322 increases by an amount corresponding to a count value corresponding to the amount of data of frame #1 that is transmitted. As a result, in the example illustrated in FIG. 4, the count value of the counter 322 exceeds the upper-limit value.

In the example illustrated in FIG. 4, when the transmission of frame #1 is finished, the frame buffer 211 has already received and held frame #2. When the transmission of frame #1 is finished, tokens that are more than or equal to the amount of data of frame #2 remain in the token bucket 310. However, since the count value of the counter 322 is larger than or equal to the upper-limit value, the buffer control section 33 suspends an instruction for transmitting frame #2 that was received next, until time point t₂ at which the count value of the counter 322 is reset to 0.

The timer 320 measures a certain period of time T. The count value of the counter 322 to which the count value corresponding to the amount of data of frame #1 is added is reset to 0 by the counter control section 321, for example, at time point t₂ (illustrated in FIG. 4) at which the measurement of the certain period of time T is finished. When the count value of the counter 322 is reset to 0, the count value of the counter 322 falls below the predetermined upper-limit value. Thus, at time point t₂ at which the count value of the counter 322 was reset to 0, the buffer control section 33 issues, to the frame buffer 211, an instruction for transmitting frame #2. As a result, at time point t₂, frame #2 is transmitted from the communication apparatus 20.

Similarly, at time point t₂ at which frame #2 is transmitted, the token control section 311 removes, from the token bucket 310, tokens corresponding to the amount of data of frame #2 that is transmitted. Also, at time point t₂ at which frame #2 is transmitted, the counter control section 321 adds, to the count value of the counter 322, a count value corresponding to the amount of data of frame #2 that is transmitted. Thus, the transmission of frame #3 that was received next is suspended until time point t₃ at which the count value of the counter 322 is reset to 0.

As described above, even when tokens corresponding to the amount of data of frames transmitted with burstiness exist in the token bucket 310, the amount of data that is transmitted in the certain period of time measured by the timer 320 is limited by the count value of the counter 322. As a result, even when the communication apparatus 20 receives frames having burstiness, it is possible to transmit the individual frames over a longer period of time in a distributed manner. As a result, it is possible to inhibit overflow of a reception buffer in the communication apparatus 20 at a receiving end.

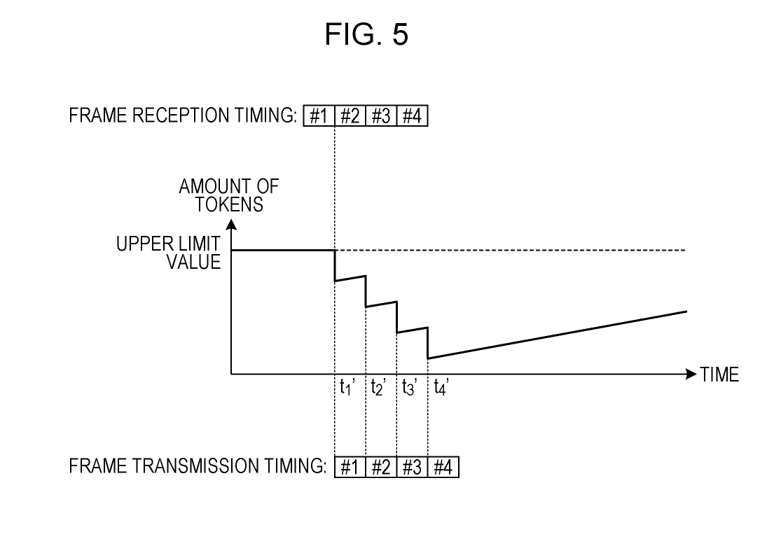

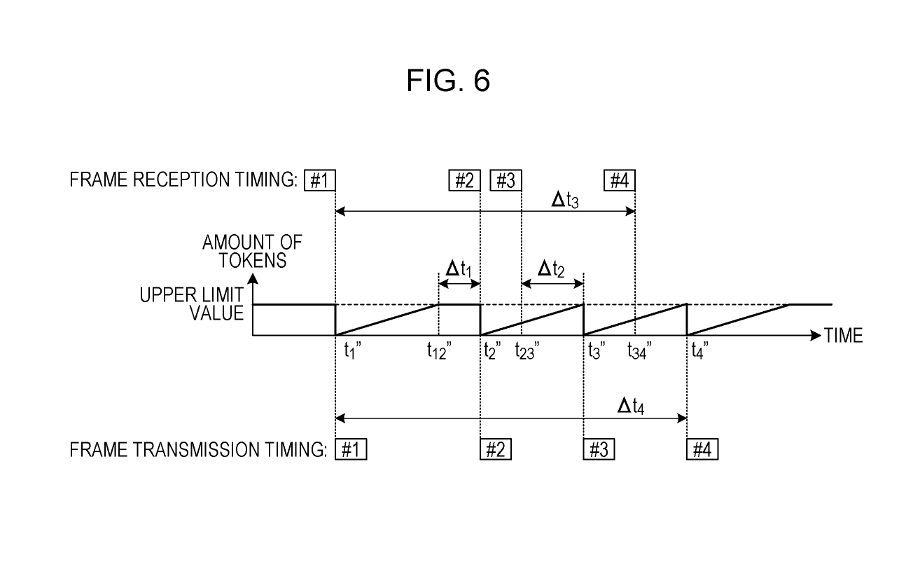

A case in which the token management section 31 controls frame transmission without use of the burst management section 32 will now be described as a comparative example. FIGS. 5 and 6 are graphs illustrating frame transmission control in the comparative example. As illustrated in FIG. 5, when the frame buffer 211 continuously receives frames #1 to #4 having burstiness, frames #1 to #4 are immediately transmitted when tokens corresponding to the amount of data of frames #1 to #4 exist in the token bucket 310.

As a result, for example, as illustrated in FIG. 5, frames #1 to #4 are transmitted to the communication apparatus 20 at a receiving end at time points t₁′ to t₄′, while the burstiness at the time of the reception is maintained. In this case, when tokens corresponding to the received frames exist in the token bucket 310, the communication apparatus 20 transmits the frames corresponding to the tokens in the token bucket 310 by using the band of the channel of the transmitting end. For example, when the band of the transmitting-side channel of the communication apparatus 20 is 1 Gbps, frames are transmitted at 1 Gbps in a bursty manner on a short term basis, even when 500 Mbps band control is performed for a user on a long term basis.

As a result, in the communication apparatus 20 at the receiving end, the reception buffer overflows, so that some of the frames are discarded. In particular, for a communication apparatus 20 whose reception buffer is small or for a communication apparatus 20 whose frame processing performance is low, the reception buffer is likely to overflow. Also, for a communication apparatus 20 that is connected to a plurality of other communication apparatuses 20, data having burstiness are intensively received from the other communication apparatuses 20, and thus the reception buffer overflows frequently.

In contrast, the communication apparatus 20 in the present embodiment limits the amount of data of frames to be transmitted in a certain period of time. Thus, even when frames transmitted with burstiness are to be transferred to another communication apparatus 20, the individual frames can be transferred over a longer period of time in a distributed manner. As a result, it is possible to reduce the burstiness of data transmitted from another communication apparatus 20, and it is possible to suppress the occurrence of overflow of the reception buffer in the communication apparatus 20 at the receiving end.

FIG. 6 illustrates a comparative example of a case in which the upper-limit value of the token bucket 310 is reduced to reduce the burstiness of frames. In an asynchronous network in which variable-length frames are transmitted, transmission intervals of the frames fluctuate. For example, consider a case in which the transmission intervals of frames #1 to #4 vary and the frame buffer 211 receives frames #1 to #4 at timings as illustrated in FIG. 6.

For example, when the frame buffer 211 receives frame #1, tokens corresponding to the amount of data of frame #1 exist in the token bucket 310, as illustrated in FIG. 6, and thus the frame buffer 211 immediately transmits frame #1 at time point t₁″. In addition, tokens corresponding to the amount of data of frame #1 are removed from the token bucket 310 at time point t₁″. Then, tokens are put in the token bucket 310, and eventually, the tokens in the token bucket 310 reach the upper-limit value at time point t₁₂″.

Then, when frame #2 is received at time point t₂″, the frame buffer 211 immediately transmits frame #2, since tokens corresponding to the amount of data of frame #2 exist in the token bucket 310. In addition, at time point t₂″, tokens corresponding to the amount of data of frame #2 are removed from the token bucket 310.

Next, when the frame buffer 211 receives frame #3 at time point t₂₃″, tokens corresponding to the amount of data of frame #3 do not exist in the token bucket 310. Accordingly, the frame buffer 211 suspends transmission of frame #3 until time point t₃″ at which tokens corresponding to the amount of data of frame #3 are accumulated in the token bucket 310. At time point t₃″, the frame buffer 211 transmits frame #3. In addition, at time point t₃″, tokens corresponding to the amount of data of frame #3 are removed from the token bucket 310.

Next, when the frame buffer 211 receives frame #4 at time point t₃₄″, tokens corresponding to the amount of data of frame #4 do not exist in the token bucket 310. Thus, the frame buffer 211 suspends transmission of frame #4 until tokens corresponding to the amount of data of frame #4 are accumulated in the token bucket 310. Then, at time point t₄″, the frame buffer 211 transmits frame #4. At time point t₄″, tokens corresponding to the amount of data of frame #4 are removed from the token bucket 310.

In this case, in a period Δt₁ from time point t₁₂″ at which the amount of tokens in the token bucket 310 reaches the upper limit until time point t₂″ at which next frame #2 is received, no tokens are put in the token bucket 310, and the amount of tokens therein is maintained at the upper-limit value. Then, as a result of the transmission of frame #2, tokens corresponding to the amount of data of frame #2 are removed from the token bucket 310 at time point t₂″. As a result, it takes an extra amount of time corresponding to the period Δt₁, until tokens corresponding to the amount of data of frame #3 to be transmitted next are accumulated in the token bucket 310, and thus the transmission of frame #3 is postponed by an amount of time corresponding to a period Δt₂.

As a result, frames #1 to #4 received in a period Δt₃ are transmitted in a period Δt₄ that is longer than the period Δt₃. Consequently, the received frames are transferred by the communication apparatus 20, and thus the data rate decreases. When a plurality of communication apparatuses 20 exist on a communication route, the data rate decreases further, thus making it difficult to maintain the guaranteed band for the user. As described above, when the band control is performed using only the token management section 31, making an attempt to reduce the burstiness of frames makes it difficult to maintain the communication band, owing to fluctuation of the frames, and making an attempt to maintain the communication band makes it difficult to reduce the burstiness.

In contrast, in the communication apparatus 20 in the present embodiment, since the token management section 31 and the burst management section 32 are used, the user band guaranty can be realized by the token management section 31, and the burst suppression can be realized by the burst management section 32. Thus, it is possible to independently control maintaining the guaranteed band and suppressing bursts, and it is possible to achieve both maintaining the guaranteed band and suppressing bursts.

In the present embodiment, the certain period of time T measured by the timer 320 is, for example, 1 millisecond, and the upper-limit value of the count value of the counter 322 is set to an appropriate value in order to reduce the burstiness in the certain period of time T. The amount of data that is transmittable per second based on the guaranteed band is controlled by the token bucket 310. Thus, the relationship between the certain period of time T measured by the timer 320 and the upper-limit value of the count value of the counter 322 is set so as to satisfy, for example, relational expression (1) below:

Guaranteed Band (bps)<Upper-Limit Value (bit)/Certain Period of Time T (second) (1)

In the present embodiment, the “upper-limit value (bit)” and the “certain period of time T (second)” are selected so that the value of the “upper-limit value (bit)/certain period of time T (second)” of the right-hand side of relational expression (1) is, for example, 1.5 to 2 times the value of the “guaranteed band (bps)” of the left-hand side. The administrator of the communication apparatus 20 or the like pre-sets the values of the “upper-limit value (bit)”, the “certain period of time T (second)”, and so on for the control circuit 30 through the control line by using the control terminal 40.

[Operation of Control Circuit 30]

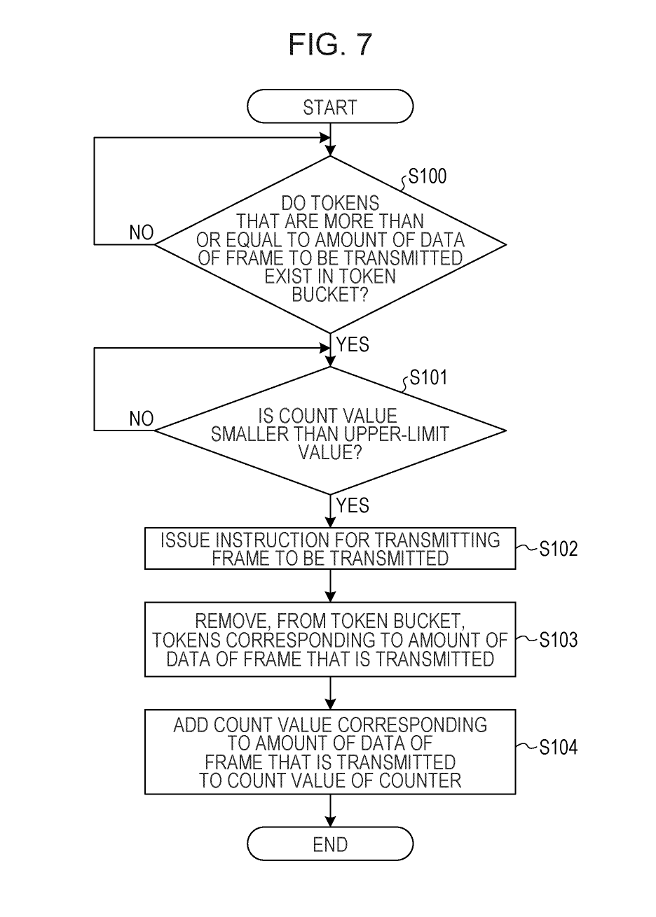

FIG. 7 is a flowchart illustrating an example of transmission control processing in the first embodiment. For example, upon receiving, from the frame buffer 211, the amount of data of a frame to be transmitted, the control circuit 30 starts transmission control processing illustrated in this flowchart. Each time the timer 320 measures the certain period of time, the counter control section 321 resets the count value of the counter 322 to 0, independently of the transmission control processing illustrated in FIG. 7.

The transmission control processing illustrated in FIG. 7 is processing for issuing an instruction for transmitting a frame to be transmitted, when the remaining amount of tokens is larger than or equal to the amount of data of the frame to be transmitted and the amount of data of a frame transmitted in the certain period of time is smaller than an upper-limit value.

First, the buffer control section 33 queries the token control section 311 about the remaining amount of tokens. The buffer control section 33 then compares the remaining amount of tokens which is returned from the token control section 311 with the amount of data of a frame to be transmitted, to determine whether tokens that are more than or equal to the amount of data of the frame to be transmitted exist in the token bucket 310 (S100). When the tokens in the token bucket 310 are less than the amount of data of the frame to be transmitted (NO in S100), the buffer control section 33 waits for a predetermined amount of time (for example, a few microseconds) and re-executes the process illustrated in step S100.

On the other hand, when tokens that are more than or equal to the amount of data of the frame to be transmitted exists in the token bucket 310 (YES in S100), the buffer control section 33 queries the counter control section 321 about the count value of the counter 322. The counter control section 321 reads the count value of the counter 322 and returns the read count value to the buffer control section 33. The buffer control section 33 compares the count value returned from the counter control section 321 with a predetermined upper-limit value, to determine whether the count value is smaller than the upper-limit value (S101). When the count value is larger than or equal to the upper-limit value (NO in S101), the buffer control section 33 waits for a predetermined amount of time (for example, a few microseconds) and re-executes the process illustrated in step S101.

On the other hand, when the count value is smaller than the upper-limit value (YES in S101), the buffer control section 33 issues, to the frame buffer 211, an instruction for transmitting the frame to be transmitted (S102). As a result, the frame to be transmitted is transmitted. The buffer control section 33 then sends, to the token control section 311, the amount of data of the frame that is transmitted. The token control section 311 removes, from the token bucket 310, tokens corresponding to the amount of data of the frame that is transmitted (S103).

Next, the buffer control section 33 sends, to the counter control section 321, the amount of data of the frame that is transmitted. The counter control section 321 adds, to the count value of the counter 322, a count value corresponding to the amount of data of the frame that is transmitted (S104). The control circuit 30 ends the transmission control processing illustrated in this flowchart.

[Advantages of First Embodiment]

As described above, according to the communication apparatus 20 in the present embodiment, it is possible to suppress a burst of frames, while maintaining the guaranteed band.

### Second Embodiment

A control circuit 30 in the present embodiment differs from the control circuit 30 in the first embodiment in that a plurality of timers 320 and a plurality of counters 322 are provided. Since overviews of the communication system 10 and the communication apparatus 20 are the same as or similar to those in the first embodiment, descriptions thereof are not given hereinafter.

[Control Circuit 30]

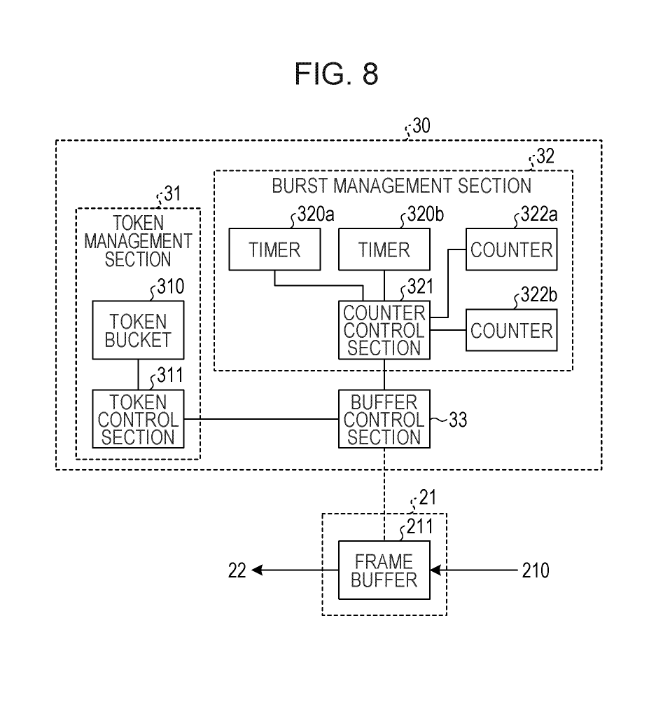

FIG. 8 is a block diagram illustrating an example of the control circuit 30 in the second embodiment. The burst management section 32 in the present embodiment has timers 320a and 320b, a counter control section 321, and counters 322a and 322b. In FIG. 8, elements that are denoted by the same reference numerals as those in FIG. 3 have functions that are the same as or similar to those in FIG. 3, except for the points described below. Thus, descriptions of the same or similar elements are not given hereinafter.

The timers 320a and 320b repeatedly measure certain periods of time (for example, 1 millisecond), respectively. However, the timers 320a and 320b are different from each other in the timings of starting and finishing the measurement of the certain periods of time. In the present embodiment, the timer 320a and the timer 320b differ from each other in the timings of starting and finishing the measurement of the certain periods of time by a half cycle (for example, 500 microseconds).

The counter 322a is provided for the timer 320a, and the counter 322b is provided for the timer 320b. Each time the timer 320a measures the certain period of time, the counter control section 321 resets the count value of the counter 322a to 0. Also, each time the timer 320b measures the certain period of time, the counter control section 321 resets the count value of the counter 322b to 0.

Upon receiving a query from the buffer control section 33, the counter control section 321 reads the respective count values from the counters 322a and 322b and returns the read count values to the buffer control section 33. Also, upon receiving the amount of data of a transmitted frame from the buffer control section 33, the counter control section 321 adds a count value corresponding to the received amount of data to each of the count values of the counters 322a and 322b.

When the remaining amount of tokens is larger than or equal to the amount of data of a frame to be transmitted, the buffer control section 33 queries the counter control section 321 about the count values of the counters 322a and 322b. When both of the count values of the counters 322a and 322b which are returned from the counter control section 321 are smaller than a predetermined upper-limit value, the buffer control section 33 issues, to the frame buffer 211, an instruction for transmitting the frame to be transmitted. Then, the buffer control section 33 sends, to the token control section 311 and the counter control section 321, the amount of data of the frame that is transmitted.

[Frame Transmission Control]

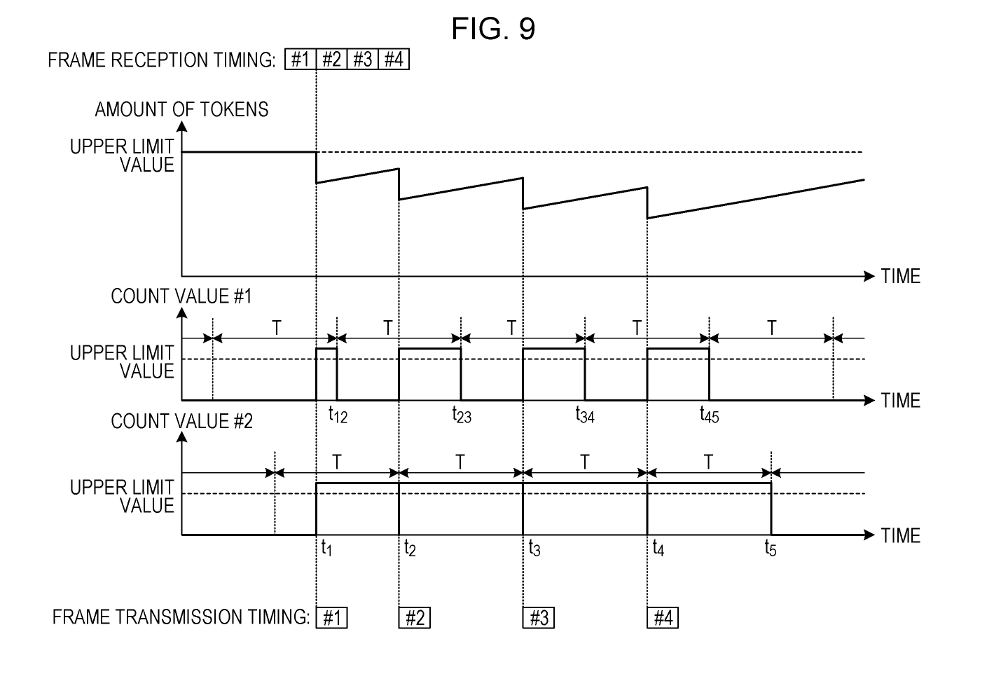

FIG. 9 is a graph illustrating an example of frame transmission control in the second embodiment. The top section in FIG. 9 illustrates an example of frame reception timings at the frame buffer 211. In FIG. 9, the second section from top illustrates changes with time in the amount of tokens that exist in the token bucket 310. In FIG. 9, the third section from top illustrates changes in count value #1 of the counter 322a with time. In FIG. 9, the fourth section from top illustrates changes in count value #2 of the counter 322b with time. The bottom section in FIG. 9 illustrates an example of frame transmission timings at the frame buffer 211.

For example, as illustrated in FIG. 9, at time point t₁ by which frame transmission has not been performed for a while, the frame buffer 211 receives frames #1 to #4 continuously transmitted with burstiness. At time point t₁, tokens that are more than or equal to the amount of data of frame #1 remain in the token bucket 310, and the count values of both of the counters 322a and 322b are smaller than the upper-limit value. Accordingly, at time point t₁, the buffer control section 33 immediately issues, to the frame buffer 211, an instruction for transmission. As a result, at time point t₁, frame #1 is transmitted from the communication apparatus 20.

At time point t₁ at which frame #1 is transmitted, the token control section 311 removes, from the token bucket 310, tokens corresponding to the amount of data of frame #1 that is transmitted. The counter control section 321 adds a count value corresponding to the amount of data of frame #1 that is transmitted to each of the count values of the counters 322a and 322b.

In the example illustrated in FIG. 9, when a count value corresponding to the amount of data of frame #1 is added to count value #1 of the counter 322a, count value #1 exceeds the upper-limit value of the counter 322a. Similarly, when a count value corresponding to the amount of data of frame #1 is added to count value #2 of the counter 322b, count value #2 of the counter 322b also exceeds the upper-limit value.

At time point t₁₂ at which the timer 320a finishes the measurement of the certain period of time T, the counter control section 321 resets count value #1 of the counter 322a to 0. Also, at time point t₂ at which the timer 320b finishes the measurement of the certain period of time T, the counter control section 321 resets count value #2 of the counter 322b to 0.

Also, in the example illustrated in FIG. 9, when the transmission of frame #1 is finished, the frame buffer 211 has already received and held frame #2. When the transmission of frame #1 is finished, tokens that are more than or equal to the amount of data of frame #2 remain in the token bucket 310. However, in the period between time point t₁₂ and time point t₂, count value #1 of the counter 322a has been reset to 0, but count value #2 of the counter 322b remains above the upper-limit value. Thus, the buffer control section 33 suspends an instruction for transmitting frame #2 that was received next, until time point t₂ at which count value #2 of the counter 322b is also reset to 0.

When count value #2 of the counter 322b is reset to 0 at time point t₂, the buffer control section 33 issues, to the frame buffer 211, an instruction for transmitting frame #2 to be transmitted. As a result, at time point t₂, frame #2 is transmitted.

Now, consider a case in which frame transmission is controlled using one timer 320a, without use of the plurality of timers 320a and 320b. When the transmission of frame #1 is finished, the frame buffer 211 has already received and held frame #2. Thus, when count value #1 of the counter 322a is reset to 0 at time point t₁₂ in FIG. 9, at time point t₁₂, the buffer control section 33 issues, to the frame buffer 211, an instruction for transmitting frame #2.

When frame #2 is transmitted at time point t₁₂, the transmission interval between frame #1 that is previously transmitted and frame #2 is reduced. Accordingly, the amount of data transmitted in a short period of time increases, the amount of data that is received by the communication apparatus 20 at a receiving end also increases temporarily, and thus the possibility that reception buffer in the communication apparatus 20 at the receiving end overflows increases. Also, in the communication apparatus 20 that receives frames transmitted from the plurality of communication apparatuses 20, the possibility that the reception buffer overflows increases further.

As time point t₁, which is the timing at which frame #1 is transmitted, is closer to time point t₁₂, which is the timing at which the timer 320a finishes the measurement of the certain period of time T, the transmission interval between frame #1 and frame #2 becomes shorter. As the transmission intervals of frames become shorter, the amount of data transmission in a short period of time increases, and the load on the reception buffer in the communication apparatus 20 at the receiving end increases.

In contrast, in the communication apparatus 20 according to the present embodiment, a plurality of timers 320 whose timings of starting and finishing the measurement of the certain periods of time T are offset from each other are used to control resetting of the counters 322 corresponding to the respective timers 320. Thus, even when a frame transmission timing is close to the timing at which one timer 320 finishes the measurement of the certain period of time T, the transmission timing is distant from the timing at which another timer 320 finishes the measurement of the certain period of time T. Accordingly, it is possible to inhibit a reduction in the transmission intervals of frames, and it is possible to reduce the load on the reception buffer in the communication apparatus 20 at the receiving end.

When the plurality of timers 320 are used, it is preferable that the respective timings at which the timers 320 start and finish the measurement of the certain periods of time T be temporally distant from each other. For example, when two timers 320 are used, it is preferable that the timing at which one of the timers 320 starts and finishes the measurement of the certain period of time T be offset by a half cycle from the timing at which the other timer 320 starts and finishes the measurement of the certain period time.

[Operation of Control Circuit 30]

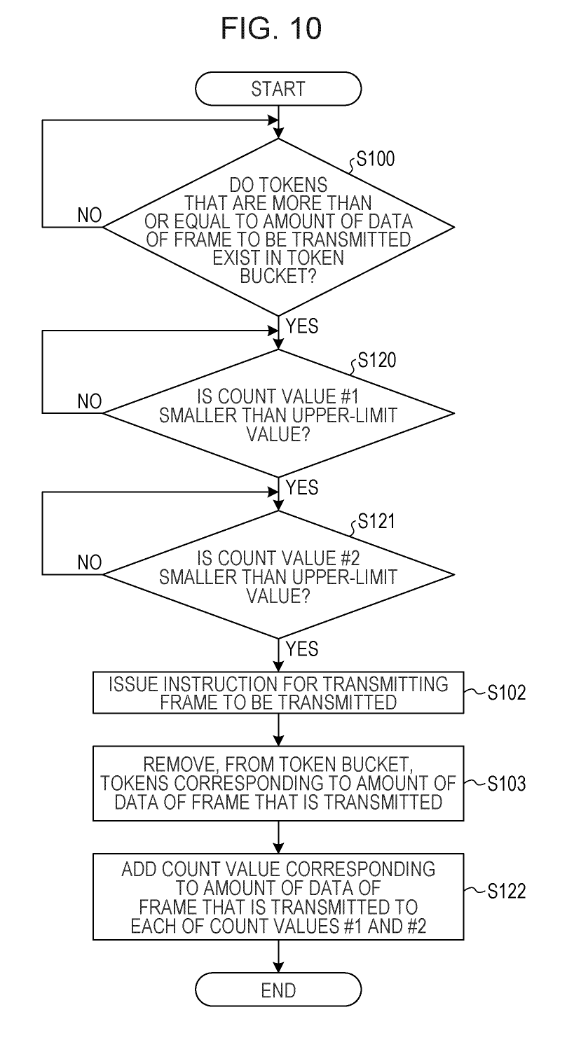

FIG. 10 is a flowchart illustrating an example of transmission control processing in the second embodiment. For example, upon receiving, from the frame buffer 211, the amount of data of a frame to be transmitted, the control circuit 30 starts the transmission control processing illustrated in this flowchart.

Each time the timer 320a measures a certain period of time, the counter control section 321 resets the count value of the counter 322a to 0, and each time the counter 322b measures a certain period of time, the counter control section 321 resets the count value of the timer 320b to 0, independently of the transmission control processing illustrated in FIG. 10. In FIG. 10, processes that are denoted by the same reference numerals as those in FIG. 7 are processes that are the same as or similar to those in FIG. 7, and thus descriptions thereof are not given hereinafter.

When tokens that are more than or equal to the amount of data of the frame to be transmitted exist in the token bucket 310 (YES in S100), the buffer control section 33 queries the counter control section 321 about count value #1 of the counter 322a. The counter control section 321 reads count value #1 from the counter 322a and returns count value #1 to the buffer control section 33. The buffer control section 33 compares count value #1 returned from the counter control section 321 with a predetermined upper-limit value, to determine whether count value #1 is smaller than the upper-limit value (S120). When count value #1 is larger than or equal to the upper-limit value (NO in S120), the buffer control section 33 waits for a predetermined amount of time and re-executes the process illustrated in step S120.

On the other hand, when count value #1 is smaller than the upper-limit value (YES in S120), the buffer control section 33 queries the counter control section 321 about count value #2 of the counter 322b. The counter control section 321 reads count value #2 from the counter 322b and returns the read count value #2 to the buffer control section 33. The buffer control section 33 compares count value #2 returned from the counter control section 321 with a predetermined upper-limit value and determines whether count value #2 is smaller than the upper-limit value (S121). When count value #2 is larger than or equal to the upper-limit value (NO in S121), the buffer control section 33 waits for a predetermined amount of time and re-executes the process illustrated in step S121.

On the other hand, when count value #2 is smaller than the upper-limit value (YES in S121), the buffer control section 33 issues, to the frame buffer 211, an instruction for transmitting the frame to be transmitted (S102). The buffer control section 33 then sends, to the token control section 311, the amount of data of the frame that is transmitted. The token control section 311 removes, from the token bucket 310, tokens corresponding to the amount of data received from the buffer control section 33 (S103).

Next, the buffer control section 33 sends, to the counter control section 321, the amount of data of the frame that is transmitted. The counter control section 321 adds a count value corresponding to the amount of data of the frame that is transmitted to each of count value #1 of the counter 322a and count value #2 of the counter 322b (S122). The control circuit 30 then ends the transmission control processing in the flowchart.

[Advantages of Second Embodiment]

As described above, according to the communication apparatus 20 in the present embodiment, it is possible to suppress a burst of frames, while maintaining the guaranteed band. Also, according to the communication apparatus 20 in the present embodiment, it is possible to suppress a burst that occurs in the vicinity of a boundary of the certain period of time.

### Third Embodiment

The control circuit 30 in a third embodiment differs from the control circuit 30 in the first embodiment in that the timer 320 is not provided. Since overviews of the communication system 10 and the communication apparatus 20 are the same as or similar to those in the first embodiment, descriptions thereof are not given hereinafter.

[Control Circuit 30]

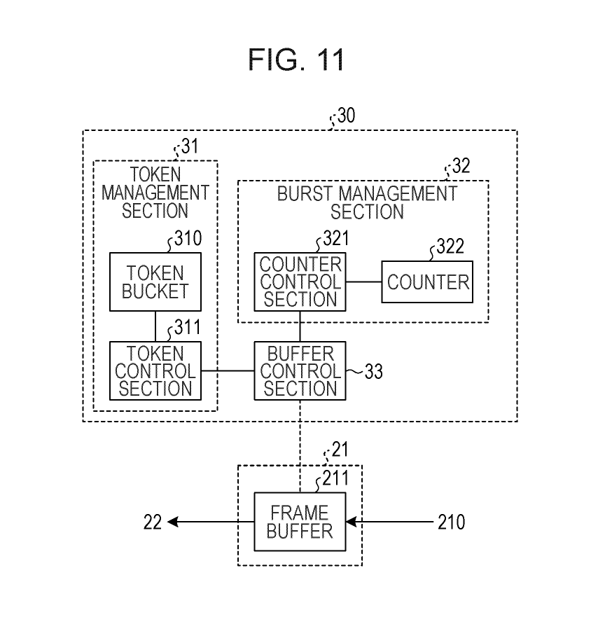

FIG. 11 is a block diagram illustrating an example of the control circuit 30 in the third embodiment. The burst management section 32 in the present embodiment has a counter control section 321 and a counter 322. In FIG. 11, elements that are denoted by the same reference numerals as those in FIG. 3 have functions that are the same as or similar to those in FIG. 3, except for the points described below. Thus, descriptions of the same or similar elements are not given hereinafter.

Upon receiving, from the buffer control section 33, the amount of data of a frame to be transmitted, the counter control section 321 adds a count value correspond to the received amount of data to the count value of the counter 322. In the present embodiment, upon receiving, from the buffer control section 33, the amount of data of the frame to be transmitted, the counter control section 321 adds a value, obtained by multiplying the received amount of data by a predetermined rate of increase A, to the count value of the counter 322.

The counter control section 321 also reduces the count value of the counter 322 to 0, as the time passes. In the present embodiment, the counter control section 321 reduces the count value of the counter 322 to 0 at a predetermined rate of decrease B per unit time. In the present embodiment, the predetermined rate of decrease B is a count value for reduction per unit time. The unit time is, for example, a time for which one bit is transmitted in a channel, and is one nanosecond in a 1 Gbps channel.

For example, when it is assumed that the guaranteed band is 300 Mbps, the upper-limit value of the token bucket 310 is 800 Kbits, and the permissible amount of burst is 160 Kbits in a 1 Gbps channel, the rate of increase A and the rate of decrease B in the present embodiment are set to, for example, 7 versus 3. Since the amount of burst that is permissible is 160 Kbits, the upper-limit value of the count value is 1120000. The rate of increase A and the rate of decrease B may be set to any values with which the band limited by the burst management section 32 does not fall below the guaranteed band controlled by the token bucket 310. However, since the count value is increased by a large amount during occurrence of a burst, and the subtraction (recovery) of the count value is gently performed during non-transmission, it is preferable that the rate of increase A be set to a larger value that the rate of decrease B. This makes it possible to suppress continuous burst transfer. The administrator of the communication apparatus 20 or the like pre-sets the upper-limit value of the count value, the value of the rate of increase A, the value of the rate of decrease B, and so on for the control circuit 30 through the control line by using the control terminal 40.

[Frame Transmission Control]

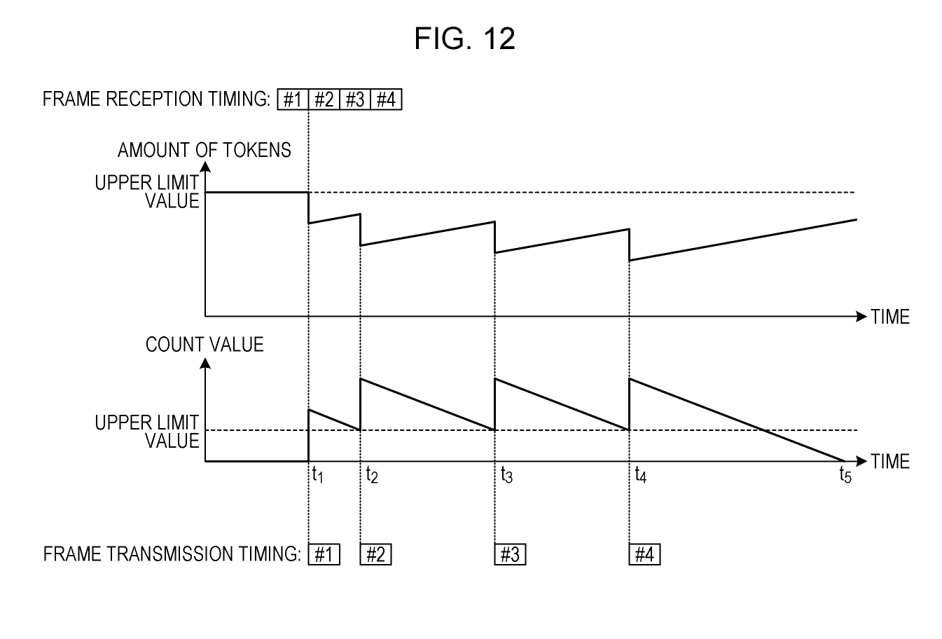

FIG. 12 is a graph illustrating an example of frame transmission control in the third embodiment. The top section in FIG. 12 illustrates an example of frame reception timings at the frame buffer 211. In FIG. 12, the second section from top illustrates changes with time in the amount of tokens that exist in the token bucket 310. In FIG. 12, the third section from top illustrates changes in the count value of the counter 322 with time. Also, the bottom section in FIG. 12 illustrates an example of frame transmission timings at the frame buffer 211.

For example, as illustrated in FIG. 12, at time point t₁ by which frame transmission has not been performed for a while, the frame buffer 211 receives frames #1 to #4 continuously transmitted with burstiness. At time point t₁, tokens that are more than or equal to the amount of data of frame #1 remain in the token bucket 310, and the count value of the counter 322 is smaller than the upper-limit value. Thus, the buffer control section 33 immediately issues, to the frame buffer 211, an instruction for transmission. As a result, at time point t₁, frame #1 is transmitted from the communication apparatus 20.

At time point t₁ at which frame #1 is transmitted, the token control section 311 removes, from the token bucket 310, tokens corresponding to the amount of data of frame #1 that is transmitted. Also, at time point t₁ at which frame #1 is transmitted, the counter control section 321 adds a value, obtained by multiplying the amount of data of frame #1 that is transmitted by a rate of increase A, to the count value of the counter 322. As a result, at time point t₁, the count value of the counter 322 increases by an amount corresponding to the count value corresponding to the amount of data of frame #1 that is transmitted.

In the example illustrated in FIG. 12, when the value obtained by multiplying the amount of data of frame #1 by the rate of increase A is added to the count value of the counter 322, the count value of the counter 322 exceeds the upper-limit value. Thus, the transmission of frame #2 that was received next is suspended until time point t₂ at which the count value of the counter 322 falls below the upper-limit value.

Each time the unit time passes, the counter control section 321 causes a count value corresponding to the predetermined rate of decrease B to be reduced from the count value of the counter 322. As a result, for example, as illustrated in FIG. 12, the count value of the counter 322 falls below the upper-limit value at time point t₂. Since tokens that are more than or equal to the amount of data of frame #2 to be transmitted remain in the token bucket 310 at time point t₂, as illustrated in FIG. 12, the buffer control section 33 issues, to the frame buffer 211, an instruction for transmission. As a result, at time point t₂, frame #2 to be transmitted is transmitted.

Similarly, at time point t₂ at which frame #2 is transmitted, the token control section 311 removes, from the token bucket 310, tokens corresponding to the amount of data of frame #2 that is transmitted. Also, at time point t₂ at which frame #2 is transmitted, the counter control section 321 adds, to the count value of the counter 322, a count value corresponding to the amount of data of frame #2 that is transmitted. Thus, the transmission of frame #3 that was received next is suspended until time point t₃ at which the count value of the counter 322 falls below the upper-limit value.

As described above, even when tokens corresponding to the amount of data of frames that are continuously received in a short period of time exist in the token bucket 310, the amount of data to be transmitted is limited until the count value of the counter 322 falls below the upper-limit value. As a result, even when the communication apparatus 20 receives frames having burstiness, it is possible to transmit the individual frames over a longer period of time in a distributed manner.

[Counter Control Processing]

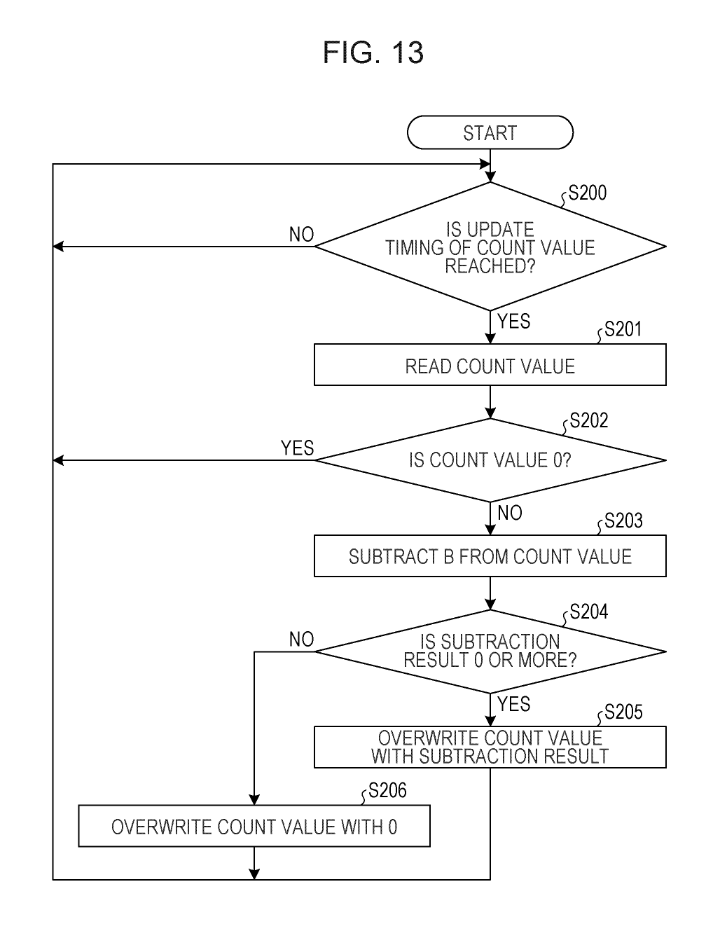

FIG. 13 is a flowchart illustrating an example of counter control processing in the third embodiment. The counter control processing illustrated in FIG. 13 is processing for reducing the count value of the counter 322 at a predetermined rate of decrease B for each unit time.

First, the counter control section 321 determines whether a unit time has passed, to thereby determine whether an update timing of the count value is reached (S200). When the update timing of the count value is not reached (NO in S200), the counter control section 321 re-executes the process illustrated in step S200.

On the other hand, when the update timing of the count value is reached (YES in S200), the counter control section 321 reads the count value from the counter 322 (S201). The counter control section 321 determines whether the count value is 0 (S202). When the read count value is 0 (YES in S202), the counter control section 321 re-executes the process illustrated in step S200.

On the other hand, when the count value is not 0 (NO in S202), the counter control section 321 subtracts a predetermined rate of decrease B from the count value (S203). The counter control section 321 then determines whether the subtraction result is 0 or more (S204). When the subtraction result is 0 or more (YES in S204), the counter control section 321 overwrites the count value of the counter 322 with the subtraction result (S205). On the other hand, when the subtraction result is smaller than 0 (NO in S204), the counter control section 321 overwrites the count value of the counter 322 with 0 (S206). The counter control section 321 re-executes the process illustrated in step S200.

[Operation of Control Circuit 30]

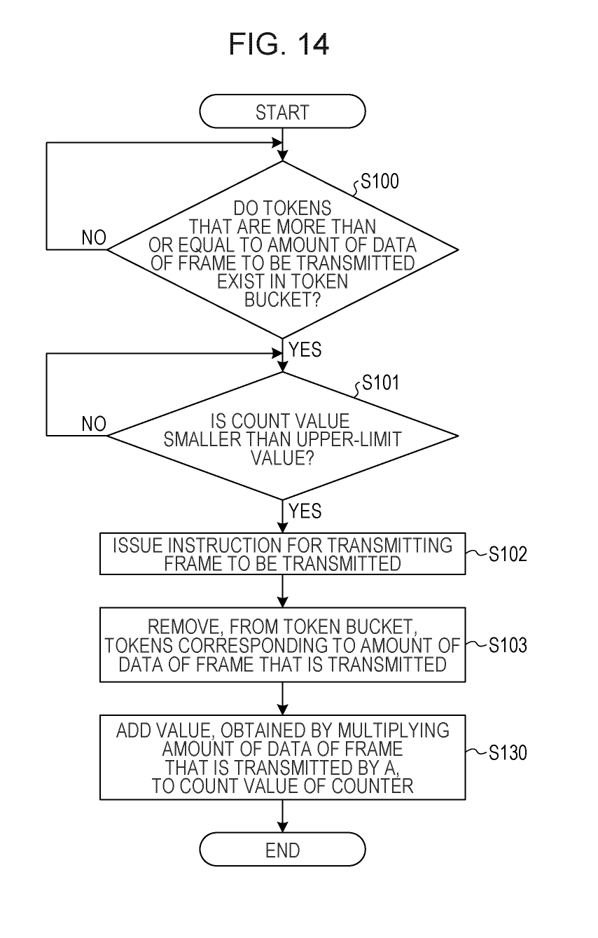

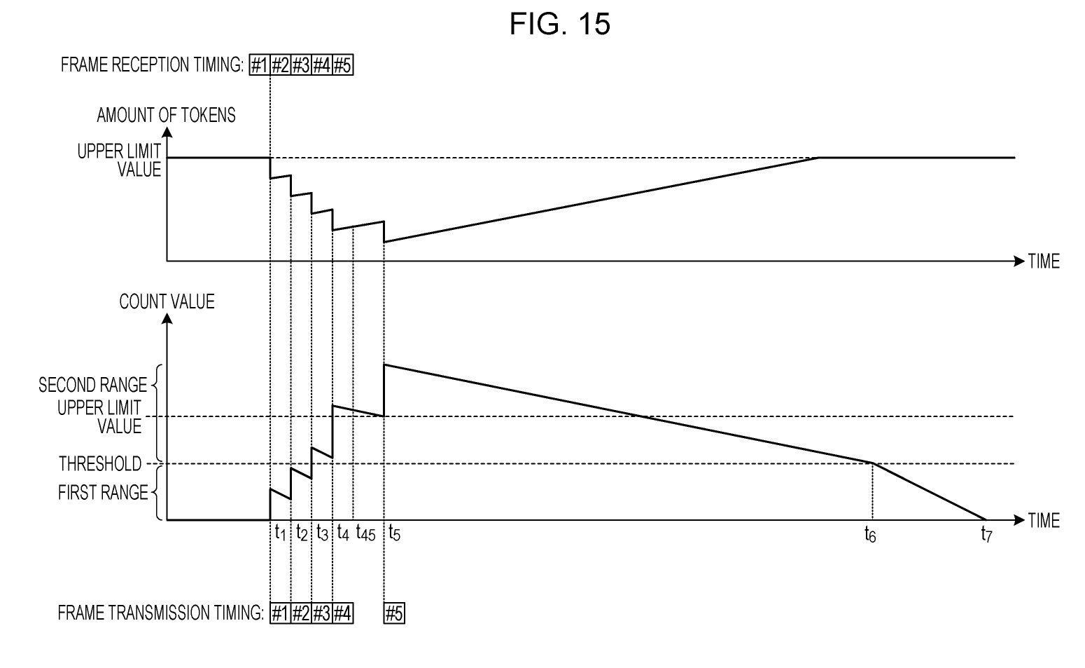

FIG. 14 is a flowchart illustrating an example of transmission control processing in the third embodiment. For example, upon receiving, from the frame buffer 211, the amount of data of a frame to be transmitted, the control circuit 30 starts the transmission control processing illustrated in this flowchart. In FIG. 14, processes that are denoted by the same reference numerals as those in FIG. 7 are processes that are the same as or similar to those in FIG. 7, and thus descriptions thereof are not given hereinafter.

After the token control section 311 removes, from the token bucket 310, tokens corresponding to the amount of data received from the buffer control section 33 (S103), the buffer control section 33 sends, to the counter control section 321, the amount of data of the frame to be transmitted. The counter control section 321 adds a value, obtained by multiplying the amount of data of the frame to be transmitted by a predetermined rate of increase A, to the count value of the counter 322 (S130). The control circuit 30 then ends the transmission control processing illustrated in this flowchart.

[Advantages of Third Embodiment]

As described above, according to the communication apparatus 20 in the present embodiment, since an increase and a decrease in the count value of the counter 322 can be arbitrarily set by adjusting the rate of increase A and the rate of decrease B, it is possible to achieve more effective and flexible burst control.

### Fourth Embodiment

The control circuit 30 in a fourth embodiment differs from the control circuit 30 in the third embodiment in that the rate of increase A and the rate of decrease B are changed according to the count value of the counter 322. Since overviews of the communication system 10 and the communication apparatus 20 are the same as or similar to those in the first embodiment, descriptions thereof are not given hereinafter. Since an overview of the control circuit 30 is also the same as or similar to that in FIG. 11, except for the points described below, a description of the overview is not given hereinafter.

[Frame Transmission Control]

FIG. 15 is a graph illustrating frame transmission control in the fourth embodiment. The top section in FIG. 15 illustrates an example of frame reception timings at the frame buffer 211. In FIG. 15, the second section from top illustrates changes with time in the amount of tokens that exist in the token bucket 310. In FIG. 15, the third section illustrates changes in the count value of the counter 322 with time. The bottom section in FIG. 15 illustrates an example of frame transmission timings at the frame buffer 211.

For example, as illustrated in FIG. 15, at time point t₁ by which frame transmission has not been performed for a while, the frame buffer 211 receives frames #1 to #5 continuously transmitted with burstiness. At time point t₁, tokens that are more than or equal to the amount of data of frame #1 remain in the token bucket 310, and the count value of the counter 322 is smaller than the upper-limit value. Thus, the buffer control section 33 immediately issues, to the frame buffer 211, an instruction for transmission. As a result, at time point t₁, frame #1 is transmitted from the communication apparatus 20.

At time point t₁ at which frame #1 is transmitted, the token control section 311 removes, from the token bucket 310, tokens corresponding to the amount of data of frame #1 that is transmitted. Also, at time point t₁ at which frame #1 is transmitted, the counter control section 321 adds a value, obtained by multiplying the amount of data of frame #1 that is transmitted by a predetermined rate of increase, to the count value of the counter 322.

In this case, since the count value of the counter 322 at time point t₁ is in a first range that is smaller than a predetermined threshold, the counter control section 321 adds a value, obtained by multiplying the amount of data of frame #2 that is transmitted by a first rate of increase A₁, to the count value of the counter 322.

At time point t₂ at which the transmission of frame #1 is finished, the frame buffer 211 has already received and held frame #2. In addition, at time point t₂, tokens that are more than or equal to the amount of data of frame #2 remain in the token bucket 310, and the count value of the counter 322 is smaller than the upper-limit value. Thus, the buffer control section 33 immediately issues, to the frame buffer 211, an instruction for transmission. As a result, at time point t₂, frame #2 is transmitted from the communication apparatus 20.

At time point t₂ at which frame #2 is transmitted, the token control section 311 removes, from the token bucket 310, tokens corresponding to the amount of data of frame #2 that is transmitted. Also, at time point t₂ at which frame #2 is transmitted, the counter control section 321 adds a value, obtained by multiplying the amount of data of frame #2 to be transmitted by the predetermined rate of increase (the first rate of increase A₁), to the count value of the counter 322.

Similarly, at time point t₃ at which the transmission of frame #2 is finished, the frame buffer 211 has already received and held frame #3. In addition, at time point t₃, tokens that are more than or equal to the amount of data of frame #3 remain in the token bucket 310, and the count value of the counter 322 is smaller than the upper-limit value. Thus, the buffer control section 33 immediately issues, to the frame buffer 211, an instruction for transmission. As a result, at time point t₃, frame #3 is transmitted from the communication apparatus 20.

At time point t₃ at which frame #3 is transmitted, the token control section 311 removes, from the token bucket 310, tokens corresponding to the amount of data of frame #3 to be transmitted. Also, at time point t₃ at which frame #3 is transmitted, the counter control section 321 adds a value, obtained by multiplying the amount of data of frame #3 that is transmitted by the predetermined rate of increase (the first rate of increase A₁), to the count value of the counter 322.

At time point t₄ at which the transmission of frame #3 is finished, the frame buffer 211 has already received and held frame #4. In addition, at time point t₄, tokens that are more than or equal to the amount of data of frame #4 remain in the token bucket 310, and the count value of the counter 322 is smaller than the upper-limit value. Thus, the buffer control section 33 immediately issues, to the frame buffer 211, an instruction for transmission. As a result, at time point t₄, frame #4 is transmitted from the communication apparatus 20.

At time point t₄ at which frame #4 is transmitted, the token control section 311 removes, from the token bucket 310, tokens corresponding to the amount of data of frame #4 that is transmitted. Also, at time point t₄ at frame #4 is transmitted, the counter control section 321 adds a value, obtained by multiplying the amount of data of frame #4 that is transmitted by a predetermined rate of increase, to the count value of the counter 322.

In this case, the count value of the counter 322 at time point t₄ is in a second range that is larger than the predetermined threshold. Thus, the counter control section 321 adds a value, obtained by multiplying the amount of data of frame #4 that is transmitted by a second rate of increase A₂, which is different from the first rate of increase A₁, to the count value of the counter 322. In the present embodiment, the first rate of increase A₁ has a value that is larger than the value of the second rate of increase A₂.

At time point t₄₅ at which the transmission of frame #4 is finished, the frame buffer 211 has already received and held frame #5. Also, at time point t₄₅, tokens that are more than or equal to the amount of data of frame #5 remain in the token bucket 310. However, the count value of the counter 322 is larger than or equal to the upper-limit value. Thus, the buffer control section 33 suspends an instruction for transmitting frame #5, until time point t₅ at which the count value of the counter 322 is smaller than the upper-limit value.

At time point t₅ at which the count value of the counter 322 is smaller than the upper-limit value, the buffer control section 33 issues, to the frame buffer 211, an instruction for transmission. As a result, at time point t₅, frame #5 is transmitted from the communication apparatus 20.

At time point t₅ at which frame #5 is transmitted, the token control section 311 removes, from the token bucket 310, tokens corresponding to the amount of data of frame #5 that is transmitted. Also, at time point t₅ at which frame #5 is transmitted, the counter control section 321 adds a value, obtained by multiplying the amount of data of frame #5 that is transmitted by the predetermined rate of increase (the second rate of increase A₂), to the count value of the counter 322.

Thereafter, when the frame buffer 211 does not receive a frame, the counter control section 321 reduces the count value of the counter 322 to the threshold at time point t₆ and reduces the count value of the counter 322 to 0 at time point t₇, for example, as illustrated in FIG. 15. However, in the period of time points t₁ to t₃ and the period of time points t₆ to t₇ in which the count value of the counter 322 is in the first range, the counter control section 321 reduces the count value of the counter 322 at a first rate of decrease B₁ per unit time. Also, in the period of time points t₃ to t₆ in which the count value of the counter 322 is in the second range, the counter control section 321 reduces the count value of the counter 322 at a second rate of decrease B₂ per unit time, the second rate of decrease B₂ being different from the first rate of decrease B₁. In the present embodiment, the first rate of decrease B₁ has a value that is larger than that of the second rate of decrease B₂.

Now, an example of specific numerical values will be described. In the present embodiment, the upper-limit value of the counter 322 is, for example, 1120000, and the threshold is, for example, 560000. Also, in the present embodiment, the first rate of increase A₁ used for the count value in the first range is, for example, 5, and the first rate of decrease B₁ is, for example, 5. In the present embodiment, the second rate of increase A₂ used for the count value in the second range is, for example, 10, and the second rate of decrease B₂ is, for example, 3.

Thus, in the first range in which the amount of data transmitted in a short time is small, the burst-suppressing counter does not exceed the threshold often, the increase/decrease in the count value is repeated, and thus, the burstiness of data is permitted to some degree. On the other hand, in a case in which the burstiness of frames continues, when the count value of the counter 322 exceeds the threshold to enter the second range, a new amount of increase/decrease in the counter is selected, and the count value increases to a larger value than the first range and also decreases gently. Thus, in the second range, the period in which the count value has a large value is increased compared with a case in which the count value is in the first range. Hence, in a case in which the burstiness of frames continues, the count value is more likely to reach the upper limit, which makes it easier to reduce the burstiness of frames. Accordingly, the burstiness of frames can be controlled so that it is suppressed in a more stepwise manner. The administrator of the communication apparatus 20 or the like pre-sets the upper-limit value of the count value, the threshold of the count value, the value of the first rate of increase A₁, the value of the second rate of increase A₂, the value of the first rate of decrease B₁, the value of the second rate of decrease B₂, and so on for the control circuit 30 through the control line by using the control terminal 40.

[Counter Control Processing]

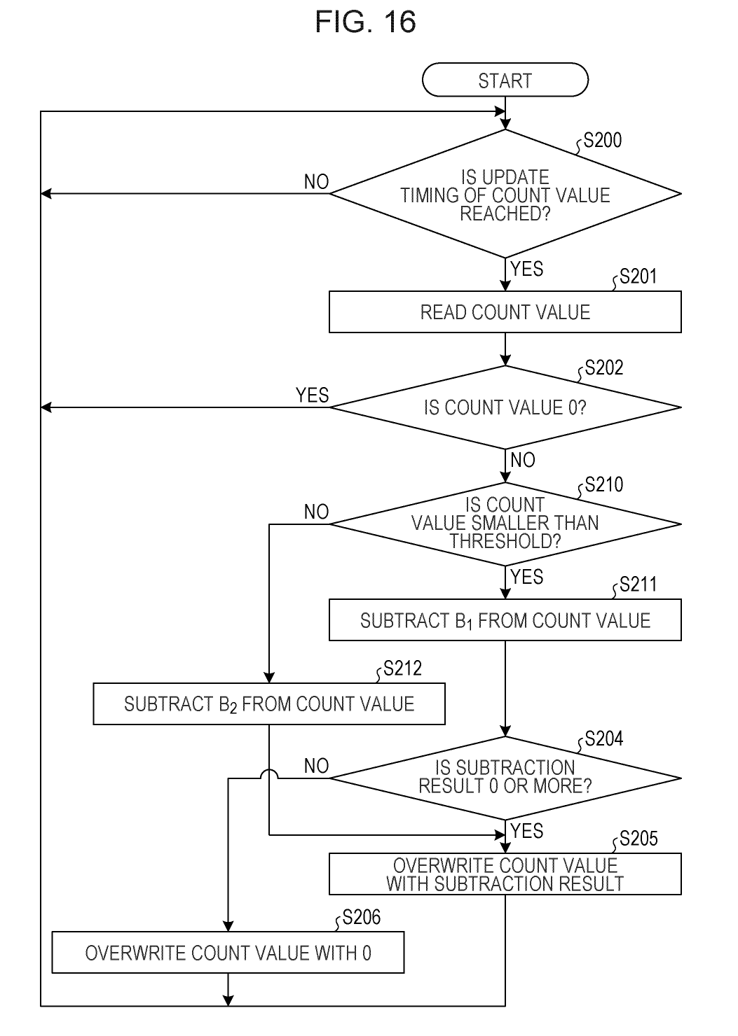

FIG. 16 is a flowchart illustrating an example of counter control processing in the fourth embodiment. In FIG. 16, processes that are denoted by the same reference numerals as those in FIG. 13 are processes that are the same as or similar to those in FIG. 13, and thus descriptions thereof are not given hereinafter.

When the count value read from the counter 322 is not 0 (NO in S202), the counter control section 321 determines that the read count value is smaller than a threshold (S210). When the count value is smaller than the threshold (YES in S210), the counter control section 321 subtracts the first rate of decrease B₁ from the count value (S211). The counter control section 321 then executes the process illustrated in step S204. On the other hand, when the count value is larger than or equal to the threshold (NO in S210), the counter control section 321 subtracts the second rate of decrease B₂ from the read count value (S212). The counter control section 321 then executes the process illustrated in step S205.

[Operation of Control Circuit 30]

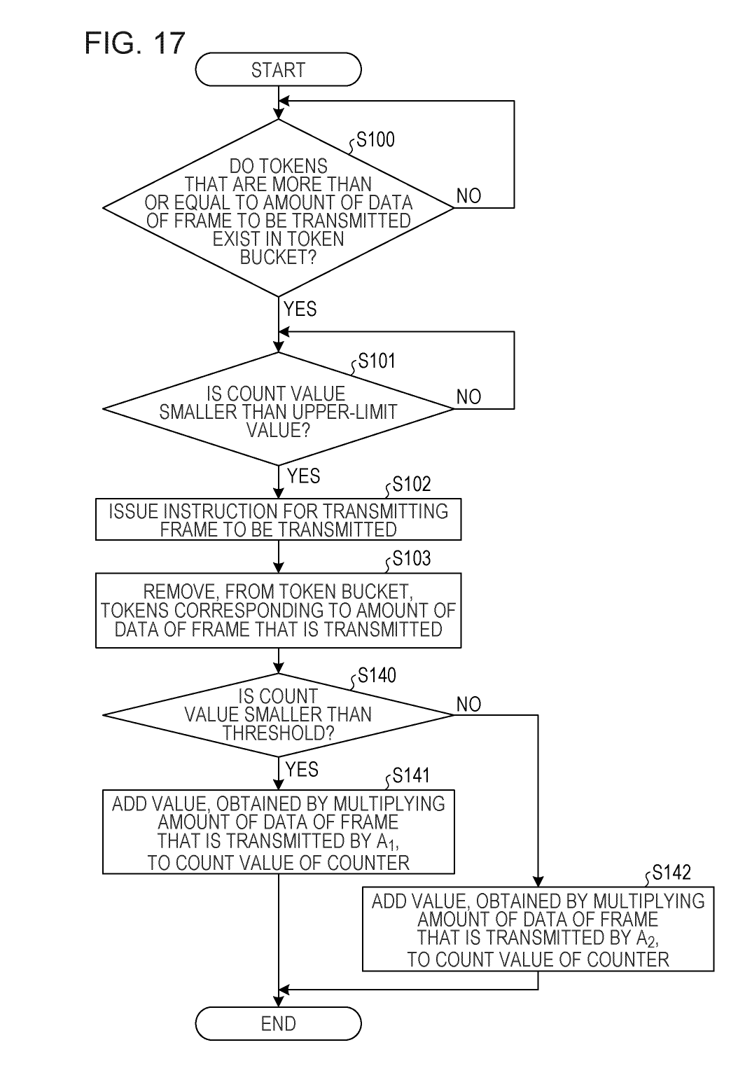

FIG. 17 is a flowchart illustrating an example of transmission control processing in the fourth embodiment. For example, upon receiving, from the frame buffer 211, the amount of data of a frame to be transmitted, the control circuit 30 starts the transmission control processing illustrated in this flowchart. In FIG. 17, processes that are denoted by the same reference numerals as those in FIG. 7 are processes that are the same as or similar to those in FIG. 7, and thus descriptions thereof are not given hereinafter.

After the token control section 311 removes, from the token bucket 310, tokens corresponding to the amount of data received from the buffer control section 33 (S103), the buffer control section 33 sends, to the counter control section 321, the amount of data of a frame that is transmitted. The counter control section 321 reads a count value from the counter 322 and determines whether the read count value is smaller than a threshold (S140).

When the read count value is smaller than the threshold (YES in S140), the counter control section 321 adds a value, obtained by multiplying the amount of data of the frame that is transmitted by the first rate of increase A₁, to the count value of the counter 322 (S141). The control circuit 30 then ends the transmission control processing illustrated in this flowchart.

On the other hand, when the read count value is larger than or equal to the threshold (NO in S140), the counter control section 321 adds a value, obtained by multiplying the amount of data of the frame that is transmitted by the second rate of increase A₂, to the count value of the counter 322 (S142). The control circuit 30 then ends the transmission control processing illustrated in this flowchart.

[Advantages of Fourth Embodiment]

As described above, according to the communication apparatus 20 in the present embodiment, it is possible to more finely control the band guaranty and the burst suppression.

[Hardware]

The constituent elements of the units described above and illustrated in the figures may or may not be physically configured as illustrated. That is, specific forms of distribution/integration of the units and portions are not limited to those illustrated, and all or any part thereof may be functionally or physically distributed or integrated in an arbitrary manner, depending on various loads, usage states, and so on.

In addition, all or any of the various processing functions of the communication apparatus 20 may be executed using a central processing unit (CPU) (or a microcomputer, such as a micro processing unit (MPU) or a micro control section unit (MCU)). Needless to say, all or any of the processing functions may also be executed using a program analyzed and executed by a CPU (or a microcomputer, such as an MPU or MCU) or using wired-logic-based hardware. A CPU may include one or more processors.

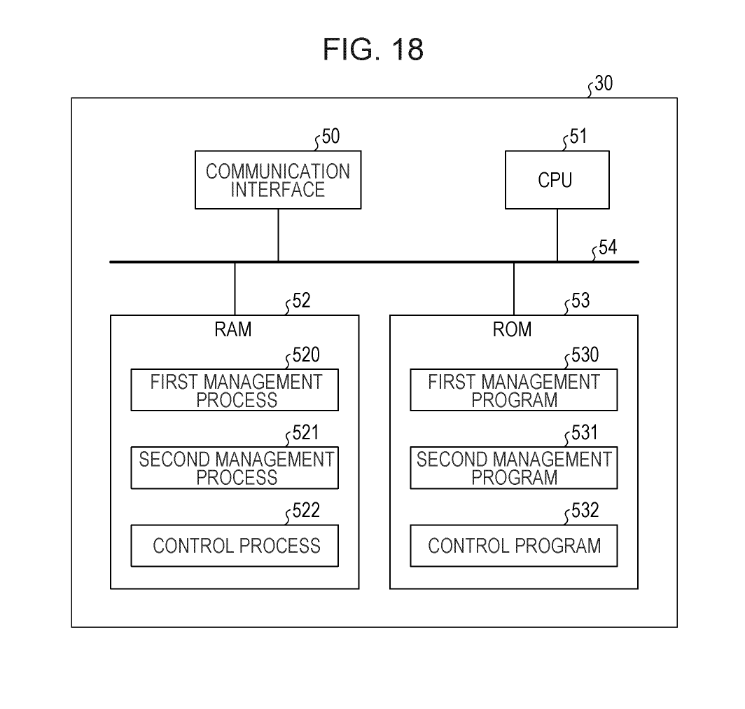

The various processes described in the above embodiments may be realized by executing a prepared program with the control circuit 30. Accordingly, a description below will be given of an example of the control circuit 30 that executes a program having functions that are equivalent to those in the above-described embodiments. FIG. 18 is a diagram illustrating an example of the hardware of the control circuit 30.

As illustrated in FIG. 18, the control circuit 30 has a communication interface 50, a CPU 51, a random access memory (RAM) 52, and a read only memory (ROM) 53. The communication interface 50, the CPU 51, the RAM 52, and the ROM 53 are connected to each other through a bus 54.

For example, as illustrated in FIG. 18, transmission processing programs including a first management program 530, a second management program 531, and a control program 532 are pre-stored in the ROM 53. The CPU 51 reads the first management program 530, the second management program 531, and the control program 532 from the ROM 53 and loads them to the RAM 52. The first management program 530, the second management program 531, and the control program 532 may be integrated together or separated from each other, as in the constituent elements illustrated in FIG. 3, 8, or 11.

For example, as illustrated in FIG. 18, the CPU 51 reads the first management program 530, the second management program 531, and the control program 532 from the ROM 53. The CPU 51 then loads a first management process 520, a second management process 521, and a control process 522 to the RAM 52. In each embodiment described above, the CPU 51 executes the first management process 520, the second management process 521, and the control process 522 loaded to the RAM 52. With this configuration, the CPU 51 achieves functions that are equivalent to those of the token management section 31, the burst management section 32, and the buffer control section 33.

In the first embodiment, the CPU 51 executes, for example, the processing illustrated in FIG. 7, by executing the first management process 520, the second management process 521, and the control process 522 loaded to the RAM 52. Also, in the second embodiment described above, the CPU 51 executes, for example, the processing illustrated in FIG. 10, by executing the first management process 520, the second management process 521, and the control process 522 loaded to the RAM 52. Also, in the third embodiment described above, the CPU 51 executes, for example, the processing illustrated in FIGS. 13 and 14, by executing the first management process 520, the second management process 521, and the control process 522 loaded to the RAM 52. In the fourth embodiment described above, the CPU 51 executes, for example, the processing illustrated in FIGS. 16 and 17, by executing the first management process 520, the second management process 521, and the control process 522 loaded to the RAM 52.

With respect to the processing sections virtually realized by the CPU 51, all of the processing sections may be realized by the CPU 51 or only a processing section or processing sections used for processing may be virtually realized. All of the first management program 530, the second management program 531, and the control program 532 may or may not be initially stored in the ROM 53. For example, each program may be stored in a portable recording medium, such as an integrated circuit (IC) card, inserted into the communication apparatus 20, and the communication apparatus 20 may obtain the program from the portable recording medium to execute the program. Also, the communication apparatus 20 may obtain each program from another computer or server apparatus, in which the programs are stored, through a wireless communication channel, a public telephone line, the Internet, a local area network (LAN), a wide area network (WAN), or the like, to execute the program.

[Others]

In the first embodiment, when tokens that are more than or equal to the amount of data of a frame to be transmitted remain in the token bucket 310, and the count value of the counter 322 is smaller than the upper-limit value, the frame to be transmitted is transmitted. However, the present technology is not limited to that example. For example, when tokens that are more than or equal to the amount of data of a frame to be transmitted remain in the token bucket 310, and another frame is not transmitted in a predetermined period of time, the frame to be transmitted may be transmitted.

For example, the counter 322 holds, as a count value, a value indicating that a frame is transmitted, and when a frame is transmitted, the counter control section 321 writes, to the count value, a value indicating that the frame is transmitted. Then, each time the timer 320 measures a certain period of time, the counter control section 321 overwrites the count value of the counter 322 with a value indicating that no frame has been transmitted.

Upon receiving, from the frame buffer 211, the amount of data of the frame to be transmitted, the buffer control section 33 queries the token control section 311 about tokens in the token bucket 310 and queries the counter control section 321 about the count value of the counter 322. When tokens that are more than or equal to the amount of data of the frame to be transmitted remain, and the count value is a value indicating that no frame has not been transmitted, the buffer control section 33 issues, to the frame buffer 211, an instruction for transmitting the frame. The counter control section 321 then overwrites the count value of the counter 322 with a value indicating that the frame has been transmitted.

With this arrangement, when a frame is transmitted, the transmission of a next frame is suspended until the timer 320 finishes the measurement of the certain period of time. Accordingly, it is possible to inhibit continuous transmission of frames, and it is possible to inhibit occurrence of burst.

In the first embodiment, the upper-limit value of the count value may also be set to a value corresponding to a small amount of data, such as a 1 bit. In such a case, when another frame is transmitted in a predetermined period of time, control may be performed so that a frame to be transmitted is transmitted.

In each embodiment described above, when the I/F circuit 21 that has received a frame sends the frame to the SW circuit 22, the buffer control section 33 controls the sending of the frame in accordance with the remaining amount of tokens and the count value, but the disclosed technology is not limited thereto. For example, when the SW circuit 22 sends a frame to the I/F circuit 21 having the channel port 210 via which the frame is to be transmitted, the buffer control section 33 may control the sending of the frame in accordance with the remaining amount of tokens and the count value. Also, when the I/F circuit 21 transmits a frame, received from the SW circuit 22, via the channel port 210 indicated by an instruction issued by the SW circuit 22, the buffer control section 33 may control the transmission of the frame in accordance with the remaining amount of tokens and the count value.

Also, in each embodiment described above, when tokens that are more than or equal to the amount of data of a frame to be transmitted remain and the count value is smaller than the upper-limit value, the buffer control section 33 issues an instruction for transmitting the frame to be transmitted, but the disclosed technology is not limited thereto. For example, when tokens that are more than or equal to the amount of data of a frame to be transmitted remain and the total of the current count value and a count value corresponding to the amount of data of the frame to be transmitted is smaller than an upper-limit value, the buffer control section 33 may issue an instruction for transmitting the frame to be transmitted. With this arrangement, since the count value is limited to a value smaller than the upper-limit value, the amount of data that is transmitted in a bursty manner can be limited to a certain value or less.

While the embodiments have been described above, the technical scope of the present disclosure is not limited to the scope described in the above-described embodiments. It is apparent to those skilled in the art that various changes and modifications are possible to the embodiments described above. Modes to which such changes or modifications have been made may also encompassed by the technical scope of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus, comprising:
a memory;
one or more processors coupled to the memory and the one or more processors execute:
a first management process that manages a remaining amount of tokens in a token bucket;
a second management process that manages an amount of data of a frame transmitted in a predetermined period of time; and
a transmission control process that controls transmission of a frame to be transmitted, based on whether the remaining amount of tokens is larger than or equal to an amount of data of the frame to be transmitted and whether the amount of data of the frame transmitted in the predetermined period of time is smaller than a predetermined amount.

2. The transmission apparatus according to claim 1,
wherein, when another frame is not transmitted in the predetermined period of time, the transmission control process determines that the amount of data of the frame transmitted in the predetermined period of time is smaller than the predetermined amount.

3. The transmission apparatus according to claim 1,
wherein the second management process comprises:
a timer that counts a predetermined certain period of time;
a counter that holds, as a count value, a value corresponding to an amount of data of a frame that is transmitted; and
a counter control process that adds, when a frame is transmitted, a value corresponding to an amount of data of the frame that is transmitted to the count value of the counter, and resets the count value of the counter to 0, each time the timer counts the predetermined period of time, and
wherein, when the remaining amount of the tokens is larger than or equal to the amount of data of the frame to be transmitted and the count value is smaller than a value corresponding to a predetermined amount of data, the transmission control process issues, to an interface circuit that performs frame transmission, an instruction for transmitting the frame to be transmitted.

4. The transmission apparatus according to claim 1,
wherein the second management process comprises:
timers that measure predetermined periods of time,
counters provided so as to correspond to the respective timers to hold, as count values, a value corresponding to an amount of data of a frame that is transmitted, and
a counter control process that adds, when a frame is transmitted, a value corresponding to an amount of data of the frame that is transmitted to each of the count values of the counters and that resets, each time each of the timers measures the predetermined period of time, the count value of the corresponding counter to 0;
wherein the timers are different from each other in timings of starting and finishing the measurement of the predetermined periods of time; and
wherein, when the remaining amount of the tokens is larger than or equal to the amount of data of the frame to be transmitted and all of the count values of the counters are smaller than or equal to a value corresponding to a predetermined amount of data, the transmission control process issues, to an interface circuit that performs frame transmission, an instruction for transmitting the frame to be transmitted.

5. The transmission apparatus according to claim 1,
wherein the second management process comprises:
a counter that holds, as a count value, a value corresponding to an amount of data of a frame that is transmitted, and
a counter control process that adds, when a frame is transmitted, a value corresponding to an amount of data of the frame that is transmitted to the count value, and that reduces the count value of the counter as time passes; and
wherein, when the remaining amount of the tokens is larger than or equal to the amount of data of the frame to be transmitted and the count value is smaller than a value corresponding to a predetermined amount of data, the transmission control process issues, to an interface circuit that performs frame transmission, an instruction for transmitting the frame to be transmitted.

6. The transmission apparatus according to claim 5,
wherein, when a frame is transmitted, the counter control process adds a value, obtained by multiplying an amount of data of the frame that is transmitted by a predetermined rate of increase, to the count value of the counter and reduces the count value of the counter at a predetermined rate of decrease per unit time.

7. The transmission apparatus according to claim 6,
wherein, in a case in which the count value when a frame is transmitted is smaller than a predetermined threshold, the counter control process adds a value, obtained by multiplying an amount of data of the frame that is transmitted by a first rate of increase, to the count value of the counter, and in a case in which the count value when a frame is transmitted is larger than or equal to the threshold, the counter control process adds a value, obtained by multiplying an amount of data of the frame that is transmitted by a second rate of increase, to the count value of the counter, the second rate of increase being different from the first rate of increase.

8. The transmission apparatus according to claim 7,
wherein, when the count value is smaller than the threshold, the counter control process reduces the count value of the counter at a first rate of decrease per unit time, and when the count value is larger than or equal to the threshold, the counter control process reduces the count value of the counter at a second rate of decrease per unit time, the second rate of decrease being different from the first rate of decrease.

9. A transmission method, comprising:
managing a remaining amount of tokens in a token bucket;
managing an amount of data of a frame transmitted in a predetermined period of time;
controlling transmission of a frame to be transmitted, based on whether the remaining amount of tokens is larger than or equal to an amount of data of the frame to be transmitted and whether the amount of data of the frame transmitted in the predetermined period of time is smaller than a predetermined amount; and
determining that the amount of data of the frame transmitted in the predetermined period of time is smaller than the predetermined amount, when another frame is not transmitted in the predetermined period of time.

10. A transmission apparatus, comprising:
a first management section that manages a remaining amount of tokens in a token bucket;
a second management section that manages an amount of data of a frame transmitted in a predetermined period of time; and
a transmission control section that controls transmission of a frame to be transmitted, based on whether the remaining amount of tokens is larger than or equal to an amount of data of the frame to be transmitted and whether the amount of data of the frame transmitted in the predetermined period of time is smaller than a predetermined amount.

11. The transmission apparatus according to claim 10,
wherein, when another frame is not transmitted in the predetermined period of time, the transmission control section determines that the amount of data of the frame transmitted in the predetermined period of time is smaller than the predetermined amount.

12. The transmission apparatus according to claim 10,
wherein the second management section comprises:
a timer that counts a predetermined certain period of time;
a counter that holds, as a count value, a value corresponding to an amount of data of a frame that is transmitted; and
a counter control section that adds, when a frame is transmitted, a value corresponding to an amount of data of the frame that is transmitted to the count value of the counter, and resets the count value of the counter to 0, each time the timer counts the predetermined period of time, and
wherein, when the remaining amount of the tokens is larger than or equal to the amount of data of the frame to be transmitted and the count value is smaller than a value corresponding to a predetermined amount of data, the transmission control section issues, to an interface circuit that performs frame transmission, an instruction for transmitting the frame to be transmitted.

13. The transmission apparatus according to claim 10,
wherein the second management section comprises:
timers that measure predetermined periods of time,
counters provided so as to correspond to the respective timers to hold, as count values, a value corresponding to an amount of data of a frame that is transmitted, and
a counter control section that adds, when a frame is transmitted, a value corresponding to an amount of data of the frame that is transmitted to each of the count values of the counters and that resets, each time each of the timers measures the predetermined period of time, the count value of the corresponding counter to 0;
wherein the timers are different from each other in timings of starting and finishing the measurement of the predetermined periods of time; and
wherein, when the remaining amount of the tokens is larger than or equal to the amount of data of the frame to be transmitted and all of the count values of the counters are smaller than or equal to a value corresponding to a predetermined amount of data, the transmission control section issues, to an interface circuit that performs frame transmission, an instruction for transmitting the frame to be transmitted.

14. The transmission apparatus according to claim 10,
wherein the second management section comprises:
a counter that holds, as a count value, a value corresponding to an amount of data of a frame that is transmitted, and
a counter control section that adds, when a frame is transmitted, a value corresponding to an amount of data of the frame that is transmitted to the count value, and that reduces the count value of the counter as time passes; and
wherein, when the remaining amount of the tokens is larger than or equal to the amount of data of the frame to be transmitted and the count value is smaller than a value corresponding to a predetermined amount of data, the transmission control section issues, to an interface circuit that performs frame transmission, an instruction for transmitting the frame to be transmitted.
